(19) United States
(12) Patent Application Publication
(10) Pub. No.: US 2022/0324160 A1
(43) Pub. Date: Oct. 13, 2022

(54) FORCED CONVECTION THERMAL HISTORY MANAGEMENT SYSTEM

(71) Applicant: Essentium, Inc., Pflugerville, TX (US)

(72) Inventors: Nirup Nagabandi, Pflugerville, TX (US); Natalie Pardivala Herrin, Pflugerville, TX (US); Daniel Carey, Austin, TX (US)

(21) Appl. No.: 17/719,826

(22) Filed: Apr. 13, 2022

Related U.S. Application Data
(60) Provisional application No. 63/174,308, filed on Apr. 13, 2021.

(51) Int. Cl. B29C 64/118; B29C 64/209; B29C 64/295; B29C 64/314; B29C 64/227; B33Y 10/00; B33Y 30/00; B33Y 40/10

(52) U.S. Cl. CPC B29C 64/118; B29C 64/209; B29C 64/295; B29C 64/314; B29C 64/227; B33Y 10/00; B33Y 30/00; B33Y 40/10

(57) ABSTRACT

The present disclosure is directed to a printer head for a three-dimensional printer, a three-dimensional printer, and a method for thermally managing printed filament temperature. The printer head including a thermal management system. The thermal management system includes a fluid passage defined by a fluid duct coupled to an air supply, a fluid nozzle coupled to the fluid duct, a first opening defined in the fluid nozzle, and a heating element included in the fluid duct. The printer head also includes an extrusion nozzle, including a first end and a second end, the first end of the extrusion nozzle is mounted to a support frame and the second end of the extrusion nozzle extends through the first opening defined in the fluid nozzle.

### FIELD

The present disclosure is directed to a forced convection thermal management system for a three-dimensional printer head and a method for managing the thermal history of a printed three-dimensional component using the forced convention thermal management system.

### BACKGROUND

A number of additive manufacturing processes involve the layer-by-layer build-up of material to form a three-dimensional component. In an extrusion-based three-dimensional printing process, often referred to as fused filament fabrication (FFF), material provided in the form of a filament is extruded from a nozzle to form successive layers resulting in a three-dimensional component. However, poor interlayer bonding may occur due to solidification of the previously deposited layer before the next layer can be deposited. Poor interlayer bonding may result in poor anisotropic properties, particularly in the z-direction, i.e., the direction in which the layers are successively built.

Various efforts have been made to improve interlayer bonding using various heating sources. For example, radio frequency sensitive additives have been added to the filaments and, sometimes in filament coatings. The printed filaments are then treated with radio frequency emissions to heat the filaments. Similarly, infrared susceptible materials may be incorporated into filaments and used in combination with infrared emitters. However, these methods of heating previously deposited layers of filament are also met with challenges.

Thus, while the current three-dimensional printers are useful for their intended purpose, there is room in the art for an improved printer design and method of producing three-dimensional components.

### SUMMARY

According to several aspects of the present disclosure, a printer head includes a support frame, a thermal management system, and an extrusion nozzle mounted to a support frame.

In further aspects, the thermal management system includes an air supply and a fluid passage. The fluid passage is defined by a fluid duct coupled to the air supply and a fluid nozzle coupled to the fluid. The fluid duct includes a heating element. In addition, the fluid nozzle defines an opening. The extrusion nozzle includes a first end and a second end, wherein the extrusion nozzle is mounted to the support frame at the first end of the extrusion nozzle and the second end of the extrusion nozzle extends through the opening of the fluid nozzle.

In further aspects of the above, the thermal management system is supported by a tray, wherein the tray is affixed to the support frame and the tray includes a base and an opening defined in the base of the tray through which the extrusion nozzle extends.

In additional aspects, the extrusion nozzle is affixed to the support frame independent of the tray and is movable relative to the tray.

In any of the above aspects, the thermal management system includes at least two fluid passages.

In any of the above aspects, a second fluid passage is defined in the fluid duct and the fluid nozzle.

In any of the above aspects, the thermal management system includes a temperature detector in operative communication with the fluid nozzle.

In any of the above aspects, the fluid duct defines at least one fin in the fluid passage.

In any of the above aspects, the thermal management system includes a gasket defining an opening, wherein the gasket is mounted on the fluid duct and the extrusion nozzle passes through the gasket opening.

In any of the above aspects, a cooling system is integrated with the thermal management system and the cooling system is coupled to the fluid passage.

According to several aspects of the present disclosure, a three-dimensional printer includes a printer head mounted in a printer housing, wherein the printer head is movable in at least one plane and the printer head includes a support frame. The printer further includes a support bed, wherein the support bed is movable relative to the printer head in the printer housing. The printer also includes a thermal management system, wherein the thermal management system includes an air supply and a fluid passage. The fluid passage is defined by a fluid duct coupled to the air supply and a fluid nozzle coupled to the fluid duct, the fluid duct includes a heating element, and the fluid nozzle defining an opening. The printer also includes an extrusion nozzle, including a first end and a second end, wherein the extrusion nozzle is mounted to a support frame at the first end of the extrusion nozzle and the second end of the extrusion nozzle extends through the opening of the fluid nozzle.

In any of the above aspects, the thermal management system is supported by a tray, wherein the tray is affixed to the support frame and the tray includes a base and an opening defined in the base of the tray through which the extrusion nozzle extends.

In any of the above aspects, the extrusion nozzle is affixed to the support frame independent of the tray and is movable relative to the tray.

In any of the above aspects, the thermal management system includes at least two fluid passages.

In any of the above aspects, the thermal management system includes a temperature detector operatively coupled to the fluid nozzle and connected to a controller, wherein the controller controls the heating element using a temperature measured by the temperature detector.

In any of the above aspects, the fluid duct defines at least one fin in the fluid passage.

In any of the above aspects, a cooling system is integrated with the thermal management system.

According to several aspects of the present disclosure, a method of thermally managing printed filament temperature through forced convection includes extruding a bead of a filament through an extrusion nozzle to form a first layer of the bead, wherein the extrusion nozzle is affixed to a support frame. The method further includes forcing fluid through a fluid passage with an air supply, wherein the fluid passage includes a fluid duct and a fluid nozzle and the fluid duct includes at least one heating element and the fluid passage and air supply are included in a thermal management system. The method yet further includes impinging the fluid against the bead of the first layer and extruding additional bead of filament through the extrusion nozzle to form a second layer of the bead, wherein the fluid alters a temperature of the first layer. The method also includes bonding the first layer of the bead to the second layer of the bead.

In further aspects of the present disclosure, the method includes raising the fluid to a temperature with the heating element, wherein the temperature is in a range of plus or minus ten degrees of a heat deflection temperature of a material forming the filament.

In any of the above aspects, the fluid is supplied to the fluid nozzle at a temperature less than a heat deflection temperature of the filament and the method further comprises cooling the first layer of the bead.

In any of the above aspects, the fluid exhibits a first temperature and is adjusted from the first temperature to a second temperature as at least one of the first layer of the bead and the second layer of the bead is being printed.

According to several aspects of the present disclosure, a method of tailoring the properties of a three-dimensionally printed component through forced convection thermal management includes extruding a bead of a filament through an extrusion nozzle to form a three-dimensional component, wherein the extrusion nozzle is affixed to a support frame. The method further includes forcing fluid through a fluid passage with an air supply, wherein the fluid passage includes a fluid duct and a fluid nozzle and the fluid duct includes at least one heating element and the fluid passage and air supply are included in a thermal management system. The method also includes impinging the fluid against the bead, wherein the fluid exhibits a fluid temperature and the fluid temperature is altered while printing the three-dimensional component.

### BRIEF DESCRIPTION OF THE DRAWINGS

The drawings described herein are for illustration purposes only and are not intended to limit the scope of the present disclosure in any way.

FIG. 1A illustrates an embodiment of a three-dimensional printer including a printer head, according to an aspect of the present disclosure;

FIG. 1B illustrates an embodiment of a printer head, according to an aspect of the present disclosure;

FIG. 2A illustrates an embodiment of a nozzle, according to an aspect of the present disclosure;

FIG. 2B illustrates an embodiment of a cross-section of a nozzle, according to an aspect of the present disclosure;

FIG. 2C illustrates an embodiment of a fluid nozzle, according to an aspect of the present disclosure;

FIG. 3A illustrates an embodiment of a forced fluid convection thermal management system, according to an aspect of the present disclosure;

FIG. 3B illustrates an embodiment of a fluid passage of a thermal management system, with the upper surface of the fluid duct removed, according to an aspect of the present disclosure;

FIG. 4 illustrates an embodiment of an extrusion nozzle, feed system, and feed motor, according to an aspect of the present disclosure;

FIG. 5 illustrates a schematic of an embodiment of a three-dimensional printer, according to an aspect of the present disclosure;

FIG. 6 illustrates an embodiment of two fluid passages of a thermal management system, with the upper surface of the fluid duct removed, according to an aspect of the present disclosure;

FIG. 7 illustrates an embodiment of a method of thermally managing a printed bead of filament temperature through forced convection, according to an aspect of the present disclosure; and

FIG. 8 illustrates an embodiment of a three-dimensional component, according to an aspect of the present disclosure.

### DETAILED DESCRIPTION

The following description is merely exemplary in nature and is not intended to limit the present disclosure, application, or uses. Thus, the use of terms such as “above,” “below,” “upper,” “lower,” “x-direction”, “y-direction”, “z-direction” or other like terms to describe a spatial relationship between various components or to describe the spatial orientation of aspects of such components should be understood to describe a relative relationship between the components or a spatial orientation of aspects of such components, respectively, as the device described herein may be oriented in other directions.

The present disclosure is directed to a forced convection thermal management system for a three-dimensional printer head and a method for managing the thermal history of a printed three-dimensional component using the forced convention thermal management system. Thermal history is understood herein as the changes in the temperature of the polymer filament and printed bead of filament prior to, during and after the printing process, the rate of change in temperature, as well as, in some aspects, the environment in which those changes occur. Forced convection thermal management is understood herein as inducing the movement of fluid of a given temperature, such as the propelling of heated or cooled fluid by an air supply or other device. The fluid impinges on a surface of a component to alter or maintain the temperature of that surface as well as, in aspects, to alter or maintain the bulk temperature of the component, i.e., alter or maintain the temperature of the component below the component surface and, in aspects, through the entire printed volume of the component, depending on the component geometry. A fluid is understood as a substance that has no fixed shape, such as a liquid or gas. Gas is understood herein to include mixtures of gasses or a single gas. In aspects, the gas includes air or inert gasses such as argon, helium, or nitrogen. Further, in aspects, the fluid is supplied at temperatures in the range of 0 degrees Celsius to 350 degrees Celsius, including all values and ranges therein.

In aspects, the forced convection thermal management system allows for control of the thermal history of the individually deposited beads, multiple layers of deposited beads, or the bulk three dimensionally printed component. In aspects, the forced convention thermal management system provides localized control of a portion of the three-dimensionally printed component, wherein the portion is located within a distance of up to 10 centimeters from the outlet of the fluid nozzle, described further herein, including all values and ranges from 0 centimeters to 10 centimeters, and more preferably from 0 centimeters to 5 centimeters from the outlet of the fluid nozzle. It should be appreciated that such localized control may be used to effect the thermal history of the entire three-dimensionally printed component.

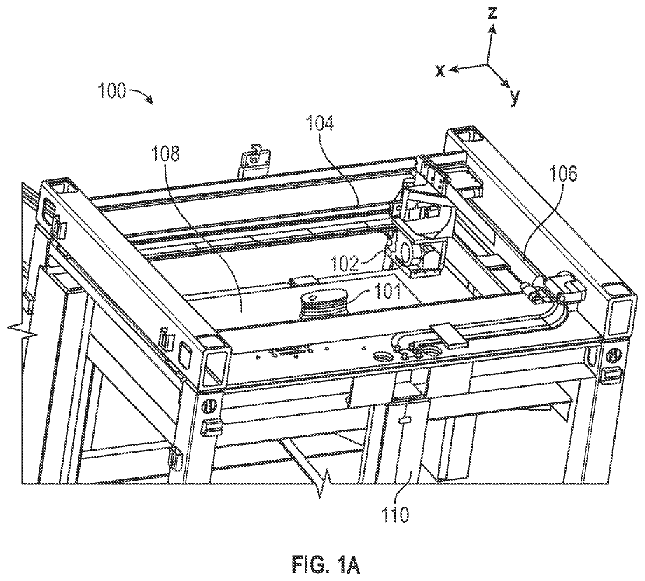

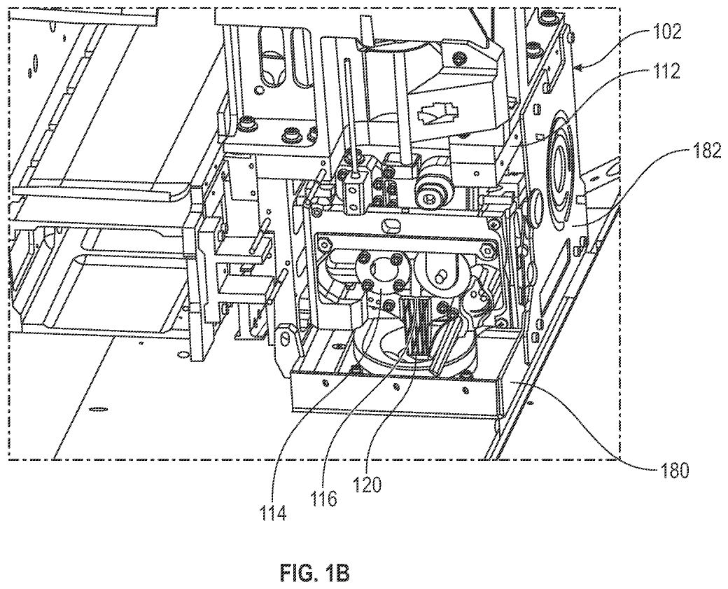

FIG. 1A illustrates an upper portion of a three-dimensional printer 100 including a printer head 102 mounted in movable fashion on a set of x-axis rails 104 and y-axis rails 106 (which define an x-axis and y-axis, respectively), allowing the printer head 102 to move in a plane defined by the x-axis and y-axis. In aspects, the printer head 102 moves at a rate of up to 500 millimeters per second, including all values and ranges from zero (0) millimeters per second and 500 millimeters per second. The three-dimensional printer 100 also includes a support bed 108 onto which a three-dimensional component 101 is formed by extruding a bead of filament from the printer head 102. The height of the support bed 108 is adjustable relative to the printer head 102 in the z-direction to increase the build volume as the layers forming the three-dimensional component 101 are formed. In the illustrated aspect, the support bed 108 is guided up and down along one or more z-axis rails 110, which define a z-axis. FIG. 1B illustrates an aspect of a printer head 102 including a support frame 112 to which the printer head motor (not illustrated), filament feed system 114, and the extrusion nozzle 120 (at a first end 116) are mounted. In the illustrated aspect, the extrusion nozzle 120 is mounted to the support frame 112 by flexures, or flexible elements, an aspect of which is further described herein.

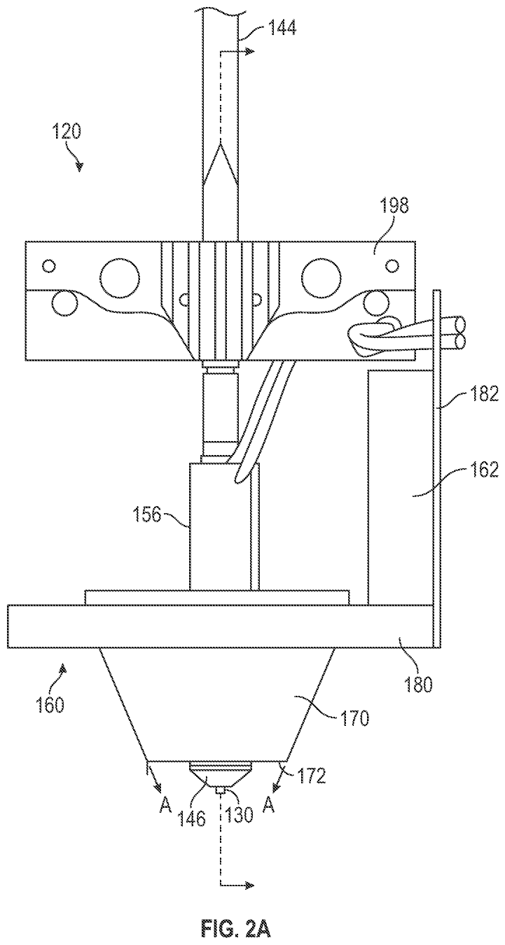

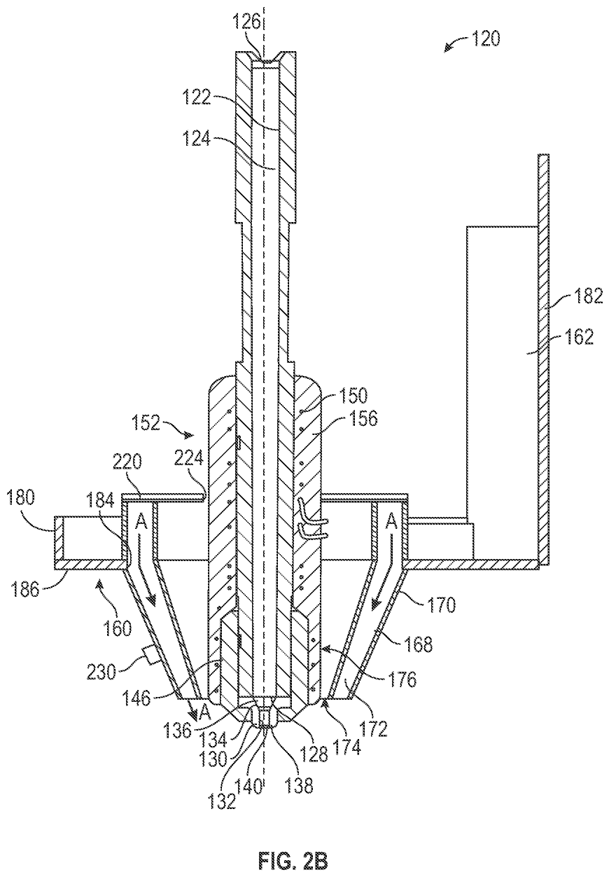

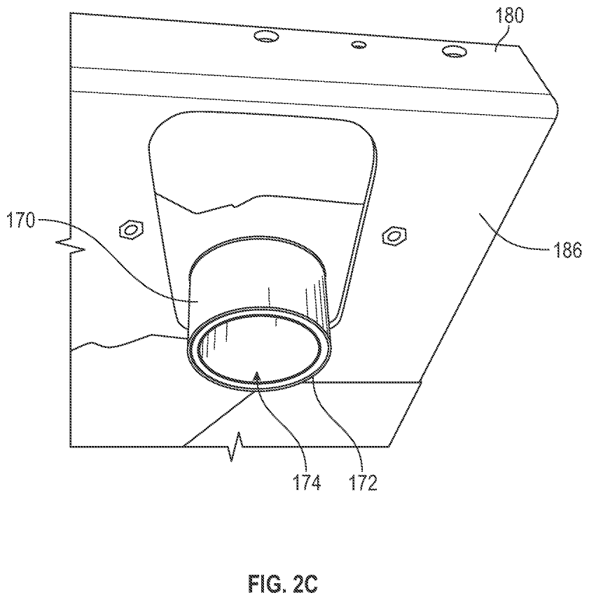

An aspect of the extrusion nozzle 120 is illustrated in FIGS. 2A and 2B. The extrusion nozzle 120 includes a through-bore 122 defined by an interior wall 124 in the extrusion nozzle 120. Filament 144 is fed into a first opening 126 defined by the extrusion nozzle 120 and passes through the through-bore 122 out of a second opening 128 and into a nozzle tip 130 affixed to the extrusion nozzle 120. The nozzle tip 130 includes a second through-bore 132. In the illustrated aspect, the second through-bore 132 includes a conical portion 134 near the entrance 136 of the nozzle tip 130. The conical portion 134 reduces the diameter of the second through-bore 132. The conical portion 134 of second through-bore 132 transitions to a cylindrical portion 138 having a reduced diameter from the diameter of the first through-bore 122 of the extrusion nozzle 120. The cylindrical portion 138 terminates at the exit opening 140.

In aspects, the nozzle tip 130 is secured onto the extrusion nozzle 120 through spot welding; however, in aspects, the nozzle tip 130 may alternatively, or additionally, be secured onto the extrusion nozzle 120 via mechanical fasteners, such as by threads or an interference fit. Further, in the illustrated aspect, a retention cap 146 is secured over the nozzle tip 130 and second opening 128 of the extrusion nozzle 120. The retention cap 146 is welded in place. Alternatively, or additionally, the retention cap 146 may be mechanically fastened to the extrusion nozzle 120, such as by threads or an interference fit.

A heating element 150 is disposed over the extrusion nozzle 120. As illustrated, the heating element 150 includes a resistive heating coil wrapped around a lower portion 152 of the extrusion nozzle 120. Wrapped around the heating element 150 and extrusion nozzle 120 is an insulator 156 that electrically insulates the heating element 150 from the extrusion nozzle 120. The insulator 156, or an additional insulator, may also provide thermal insulation of the extrusion nozzle 120 and heating element 150 from the surrounding environment.

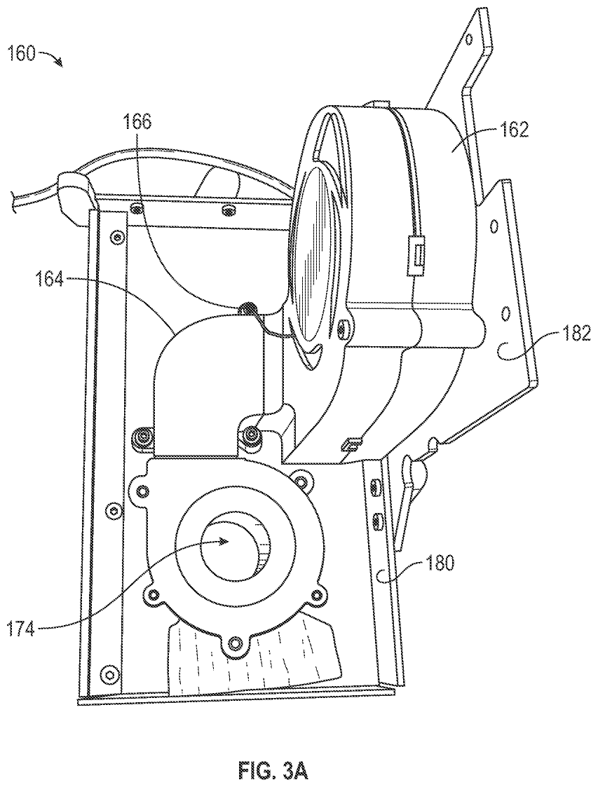

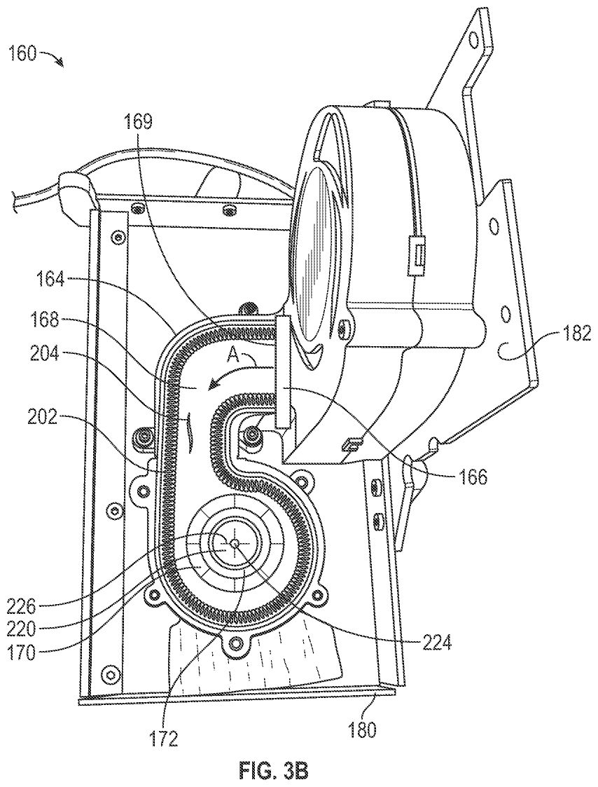

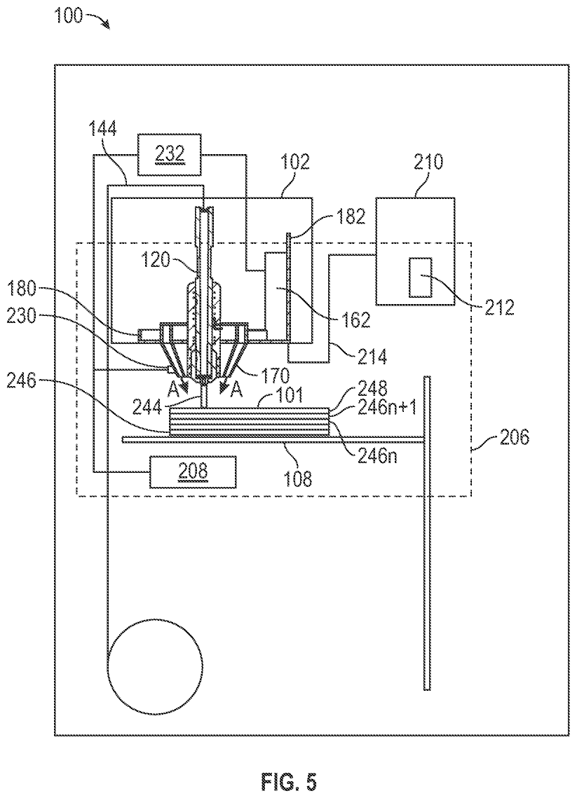

As alluded to above, the printer head 102 includes a forced convection thermal management system 160, an aspect of which is further illustrated in FIGS. 3A and 3B. The forced convection thermal management system 160 includes an air supply 162 and a fluid passage 168. In aspects, the air supply 162 is a driven air supply, which includes at least one of a fan, an air compressor, and an air pump. The fluid passage is defined by a fluid duct 164 connected to the air supply outlet 166, and a fluid nozzle 170 connected to the fluid duct 164. The fluid nozzle 170 defines an outlet 172 (see FIGS. 2A and 2B) through which the fluid A is provided to a deposited bead 244 of filament 144 (see FIG. 5). In aspects, the fluid nozzle 170 is connected to the fluid duct 164 either directly or indirectly, such as by a coupler (not illustrated). In the illustrated aspect, the fluid nozzle 170 assumes the shape of a truncated cone; however, other geometries may be assumed such as the cylindrical shape illustrated in FIG. 2C. In addition, the fluid duct 164 and fluid nozzle 170 define an opening 174 to accommodate a second end 176 (see FIG. 2B) of the extrusion nozzle 120. The second end 176 of the extrusion nozzle 120 opposes the first end 116 of the extrusion nozzle 120, which is affixed to the printer head 102 in the illustrated aspect. Further, in the illustrated aspect, the fluid nozzle 170 is concentric with the extrusion nozzle 120; however, the extrusion nozzle 120 may be offset from the center of the fluid nozzle 170. In aspects, the fluid duct 164 is formed from a polymer material, metal, metal alloy, ceramics, or combinations thereof. In addition, the fluid duct 164 is formed from a material is heat resistant and able to withstand temperatures of at least 200° C. In further aspects, the fluid nozzle 170 is also formed from a polymer material or metal or metal alloy.

In aspects, the fluid duct 164 and the fluid nozzle 170 are insulated with an insulating material, either by providing an insulating layer on at least one of the interior surface and exterior surfaces of the fluid duct 164 and fluid nozzle 170. The insulating materials include, but are not limited to, ceramic coatings, fiberglass woven blankets, or insulating mica material.

In aspects, the forced convection thermal management system 160 is supported by a tray 180. In the illustrated aspect, the tray 180 includes a side wall 182, which the air supply 162 is attached to. In aspects, the side wall 182 is affixed to the printer head 102. In addition, the tray 180 has an opening 184 defined in the base 186 of the tray 180 through which the extrusion nozzle 120 extends. In addition, the fluid nozzle 170 is mounted to the base 186 of the tray 180 and extends down from the tray 180 towards the support bed 108. In alternative aspects, a portion of the forced convention thermal management system 160 is supported in an alternative location in the three-dimensional printer 100. For example, the thermal management system 160 may be affixed to one of the x-axis rail 104, the y-axis rail 106, or on the printer chassis. In such an aspect, flexible tubing may be used to connect the air supply 162 to the fluid nozzle 170, which remains supported around the extrusion nozzle 120.

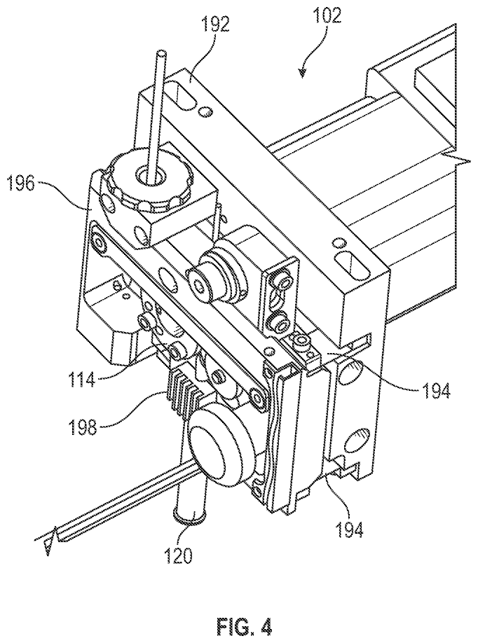

Referring again to FIG. 1B, in aspects, the extrusion nozzle 120 and tray 180 are affixed to the support frame 112. In the illustrated aspect, the tray 180 and extrusion nozzle 120 are independently affixed to the support frame 112 so that the extrusion nozzle 120 is moveable in the z-direction relative to the tray 180. In an aspect illustrated in FIG. 4, the extrusion nozzle 120 is mounted to the printer head 102 by securing the extrusion nozzle 120 in a clamp 198. The clamp 198 is affixed to a clamp plate 196, which also moves in the z-direction relative to the tray 180. Flexures 194, that is flexible elements, are used to connect the clamp plate 196 to a nozzle mounting plate 192. The flexures 194 allow the extrusion nozzle 120 and clamp plate 196 to move in the z-direction, relative to the nozzle mounting plate 192 and the remainder of the printer head 102, when a force is placed on the extrusion nozzle 120, such as when the extrusion nozzle 120 contacts the support bed 108. Allowing movement of the extrusion nozzle 120 in the z-direction may prevent the extrusion nozzle 120 from being damaged if it contacts the support bed 108 and allows for leveling of the support bed 108 in the z-direction relative to the extrusion nozzle 120. In aspects, the flexures 194 are provided at multiple points between the clamp plate 196 and the nozzle mounting plate 192 on either side of the extrusion nozzle 120.

In alternative aspects, the clamp 198 may be affixed directly to the printer head 102 and the extrusion nozzle 120 may move in the z-axis in the clamp 198. For example, the extrusion nozzle 120 may be mounted in the clamp 198 on a spring (not illustrated), which biases the extrusion nozzle 120 in the z-axis in one direction, such as towards the support bed 108. If the support bed 108 is moved up too high, the extrusion nozzle 120 may travel upward against the force of the spring. In yet further aspects, the extrusion nozzle 120 is mounted in a non-movable manner.

In aspects, the forced convection thermal management system 160 also includes one or more heating elements 202 present in the fluid passage 168, either within the fluid duct 164, the fluid nozzle 170, or within both, to heat the fluid A. Alternatively, or additionally, one or more heating elements 202 are present in the air supply 162. In aspects, the heating elements 202 are relatively high wattage, low thermal mass heating elements 202, wherein the elements exhibit a wattage in the range of 10 Watt to 1000 Watts, including all values and ranges therein, such as 40 Watts to 600 Watts, 50 Watts to 500 Watts, etc. The specific thermal mass of each of the heating elements 202 is in the range of 100 J/kg*K to 1000 J/kg*K, including all values and ranges therein. In the illustrated embodiment, the heating elements 202 include a resistive wire coil. However, alternative, or additional, heating elements 202 include, for example, infrared (IR) or ceramic heat emitting elements in the fluid passage 168, such as IR emitting or ceramic heating fins 204, provided in the fluid passage 168. In additional, or alternative aspects, hot gas from an air scrubber in an exhaust passage that vents the process chamber 206 (see FIG. 5) may be recycled and supplied to the forced convention thermal management system 160.

In aspects, the fluid A is heated by the forced convection thermal management system 160 and exhibits a temperature that is greater than the fluid within the process chamber 206 of the three-dimensional printer 100. In further aspects, the fluid A is heated to a temperature of up to 350 degrees Celsius, including all values and ranges between 20 degrees Celsius to 350 degrees Celsius, and preferably between 20 degrees Celsius and 210 degrees Celsius, and more preferably between 100 degrees Celsius and 210 degrees Celsius. In further aspects, the lower end of the range is determined by the ambient temperature in the process chamber 206 or by the ambient temperature where the fluid intake for the air supply 162 located, if it is located outside of the process chamber 206.

In aspects, a cooling system 210 is integrated into the forced convection thermal management system 160 as illustrated in FIG. 5. In aspects, the cooling system 210 is mounted within the three-dimensional printer 100 or alternatively, although not illustrated, the cooling system 210 may be mounted outside of the three-dimensional printer 100 or housed in a cart outside of the three-dimensional printer 100. In aspects, the cooling system 210 includes a chiller 212, which in some aspects includes a compressor. As illustrated, tubing 214 is used to transfer the cool fluid A from the cooling system 210 to the forced convection thermal management system 160. In other or additional aspects, the cooling system 210 includes a vortex tube. Further, moisture may be removed from fluid A supplied to the thermal management system 160 with a dehumidifier 218. The cool fluid A exhibits a temperature that is less than the temperature of the fluid A within the three-dimensional printer 100.

Referring again to FIG. 3B, fins 204 are provided, in aspects, extending from the interior surfaces of the fluid duct 164 in the fluid passage 168 to impart turbulence to the flow of fluid A traveling through the fluid passage 168, independent of whether the fins 204 are used for heating or cooling of the fluid A passing through the fluid passage 168. The fins 204 may extend along a portion of, or along all of, the fluid passage 168 including, in some aspects, within the fluid nozzle 170.

In some aspects, the flow rate of the fluid A passing through the forced convention thermal management system 160 and fluid nozzle 170 is controlled. Control of the flow rate may be used to adjust the dwell time of the fluid A in the forced convention thermal management system 160, wherein longer dwell times may equate to relatively higher fluid temperatures. Thus, in aspects, control of the flow rate is used in combination with control of the heating elements 202 or cooling system 210 to adjust and alter the temperature of the fluid A. In aspects, the flow rate and temperature of the fluid A is adjusted by adjusting the speed of the air supply 162 or alternatively, or additionally, by controlling the mass flow or volume flow using a control valve 169 included in the fluid passage 168. In the illustrated aspects, the control valve 169 is positioned at the exit 166 of the air supply 162. Alternatively, the control valve 169 is positioned just before the fluid nozzle 170 in the fluid passage 169. In further aspects, the control valve 169 is a high-speed control valve that exhibits a response time in the range of less than 200 milliseconds, such as in the range of 1 millisecond to 200 milliseconds, including all values and ranges therein from 1 millisecond to 200 milliseconds and, more preferably, less than 100 milliseconds, and yet more preferably less than 10 milliseconds. The air supply 162 and the control valve 169 are coupled to and adjusted by the controller 232. In aspects, the controller 232 selects the mass or volume flow rate of the fluid A based on factors such as the measured temperature of the fluid A. In further aspects, the volumetric flow rate of the fluid A is adjusted in the range of 0.01 standard cubic centimeter per minute to 20 standard cubic centimeters per minute (sccm), including all values and ranges therein. The flow rate of the fluid A may be altered through the course of printing a single layer or altered between layers. In addition, the flow rate of the fluid A may be altered at certain locations of the component 101 being printed or at certain features of the component 101 being printed.

In aspects, a gasket 220 is attached to the fluid duct 164 at the fluid duct opening 174, such as illustrated in FIGS. 2B and 3B, and surrounds the extrusion nozzle 120. The gasket 220 defines an opening 224 through which the extrusion nozzle 120 is received and passes through and, in further aspects, may include a number of flaps 226 as illustrated in FIG. 3B. In aspects, the gasket 220 may assist in maintaining the spacing between the extrusion nozzle 120 and the fluid nozzle 170. In additional or alternative aspects, the gasket 220 may reduce the amount of fluid flow between the fluid nozzle 170 and the extrusion nozzle 120.

In yet further aspects, a temperature sensor 230, such as a resistance temperature detector or a thermocouple, is operatively coupled to the fluid nozzle 170 to measure the temperature of the fluid A, or a temperature representative of the temperature of the fluid A, that is moving through the fluid passage 168. Operative coupling is understood herein as the positioning of the temperature sensor relative to the fluid nozzle 170 to measure the temperature of the fluid A or a temperature representative of the temperature of the fluid A, such as the temperature of the fluid nozzle 170. The positioning is determined, at least in part, by the type of temperature sensor 230 utilized. The temperature sensor 230 is, in aspects, connected to a controller 232, which controls the heating elements 202, the air supply 162 speed, and other variable components in the forced convection thermal management system 160 as well as the cooling system 210 based on electrical signals representing temperature or changes in temperature provided by the temperature sensor 230. In aspects, a power supply having a voltage in the range of 0 V to 240 V, including all values and ranges therein such as 12V or 24V, is used to power the heating element 202 and cooling system 210, if present.

It may further be appreciated that, in some aspects, multiple fluid passages 168, 238 are provided to create individual heating/cooling zones. As illustrated, one fluid passage 168, defines a first zone, and a second fluid passage 238 defines a second zone. Each fluid passage 168, 238, and associated zone, are operated at a different temperature and include separately controlled heating elements 202, 240, and each fluid passage 168, 238 includes one or more fins 204, 242. Further each fluid passage 168, 238 may be separately fed by the cooling system 210.

In view of the above, the three-dimensional printer and thermal management system 160, with or without the inclusion of the cooling system 210, provides for the relatively rapid modulation of the temperature of the fluid A, wherein the rate of temperature change is up to 100 degrees Celsius per second, including all values and ranges from 0 degrees Celsius to 100 degrees Celsius. Thus, in one, non-limiting example, in printing a 500 millimeter bead, at a printer head 102 speed of 500 mm per second, the temperature of the fluid A is adjustable up to 100 degrees Celsius from one end of the bead to the other end of the bead, where the rate of fluid A temperature change is 100 degrees Celsius per second.

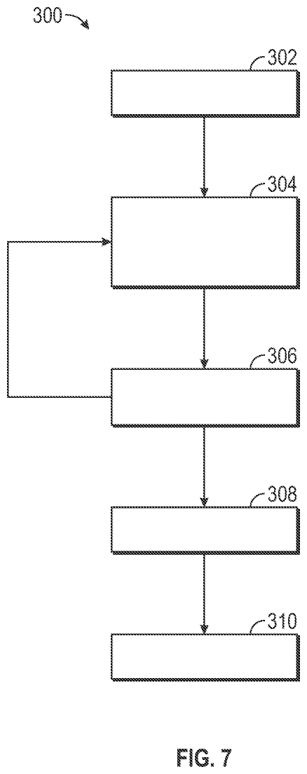

Reference is now made to FIG. 7, with further reference to FIGS. 1 through 6, illustrating an aspect of a method of printing a three-dimensional component 101 assisted by forced convection thermal management. In aspects, the method provides management of the thermal history of the filament 144 and three-dimensional component 101 during and after deposition of a bead 244 of filament 144. The method 300 includes extruding a bead 244 of a filament 144 (see FIG. 5) through an extrusion nozzle 120 mounted to the printer head 102 at block 302. The bead 244 of the filament 144 is deposited in a plurality of layers 246, 246n, 246n+1, etc., on a support bed 108. As the extrusion nozzle 120 passes over a previously deposited layer 246n to deposit another layer 246n+1 of the bead 244 of filament 144, fluid A is forced through the fluid duct 164 at block 304 and is directed around at least a portion of the extrusion nozzle 120, and in aspects around the entire circumference of the extrusion nozzle 120, towards the deposited bead 244 of filament 144 in the previous layer 246n. In further aspects, the fluid A is also directed against the layer 246n+1 of the bead 244 of the filament 144 currently being deposited in the region proximal to the extrusion nozzle 120 and fluid nozzle 170.

In aspects, the forced fluid A impinges on the previously deposited layer 246n of the bead 244 of filament 144 and heats or cools the bead 244 of filament 144 to elevate or reduce the temperature of the previously deposited layer 246 of filament 144, respectively. For example, providing fluid A of relatively high temperatures, in aspects, those within 10 degrees Celsius of the heat deflection temperature, improves bonding between adjacent layers 246n, 246n+1. In aspects, elevating the surface temperature, and in further aspects, the bulk temperature, of the previously deposited layer 246n of the bead 244 of filament 144 may promote a degree diffusion of the polymer chains across the surface boundaries of the bead 244 of filament 144 of the previously deposited layer 246n and the bead 244 of filament 144 of the newly deposited layer 246n+1. In alternative, or additional aspects, the temperature of fluid A may be adjusted to supply energy to a chemical reaction or quench a chemical reaction by altering the chemical reactivity of reactive materials that may be present in the bead 244 of filament 144, such as in the case where the bead 244 of filament 144 may be a thermoset or otherwise thermally sensitive. In yet further aspects, relatively cooler fluids A may be used to reduce or quench heat generated, such as for quenching mill heads or laser heads, or to reduce the temperature in regions of the component 101 where a thermal mass has built-up. Further, in aspects the fluid A is used to control the temperature of not only the surface of the bead 244 of filament 144 but also the bulk temperature of the component 101. This may allow for control of thermally induced characteristics such as crystallization in crystalline materials (both nucleation and crystal grain size), die swell, etc. Further, the ability to manage the thermal history, in aspects, also allows control of additional thermal, electrical, dimensional and chemical properties of the bead 244 of filament 144 and printed component 101.

The process is repeated at block 306 until the final layer 248 is extruded at block 308. In optional aspects, after the final layer 248 of the bead 244 of filament 144 is printed, at block 310, the fluid extrusion nozzle 170 is passed over the final layer 248 and the temperature of the fluid A is cooler than the glass transition temperature of the material forming the surface of the bead 244 of filament 144, cooling the bead 244 of filament 144.

In some aspects, the temperature of the forced fluid A is varied with each layer 246 to control component 101 stability. In other aspects, the temperature of the of the forced fluid A is varied across a single layer 246, wherein a portion of the layer 246 is impinged with fluid A of a relatively cooler temperature, a first temperature, and another portion of the layer 246 is impinged with forced fluid A of relatively higher temperature, a second temperature higher that is than the first temperature. In aspects, a cooler temperature is a temperature that is less than the relatively higher temperature. In further aspects, a cooler temperature is less than the glass transition temperature of the material forming the surface of the bead 244 of filament 144. For example, in aspects, the use of a cooler fluid A in discrete locations may be used to induce a stress fracture location or create a weak spot in the printed component 101 as compared to the other portions of the component 101. In other aspects, a cooler fluid A may be used in regions with a relatively high print density to reduce an undesirable temperature build-up that may cause the printed component 101 from warping. On the other hand, using a relatively hot fluid A may increase crystallinity or, in the case of thermally sensitive and chemically reactive materials, increase crosslinking of the bead 244 of filament 144 and printed component 101 in certain locations.

The temperature of the fluid A is regulated using the forced convection thermal management system 160. As alluded to above, in aspects, the temperature of the fluid A is regulated between 0 degrees Celsius to 350 degrees Celsius, including all values and ranges therein, to either heat or cool the surface of the filament or the bulk temperature of the printed component 101. In further aspects, the temperature of the fluid A is selected to increase the temperature of the surface of the deposited bead 244 of filament 144 in a previously deposited layer 246n to a temperature in the range of plus or minus 10 degrees of the heat deflection temperature, including all values and ranges therein. The heat deflection temperature is understood as the temperature at which a material begins to soften under a fixed load and, in aspects, is measured by ASTM D 648-18. The surface of the bead 244 filament 144 is understood herein to include the exterior of the bead 244 of filament 144. Thus, if the filament 144 includes a coating, the surface of the deposited bead 244 of filament 144 is the surface of the coating and the temperature the surface is raised to or maintained at a temperature in the range of the heat deflection temperature, including all values and ranges therein.

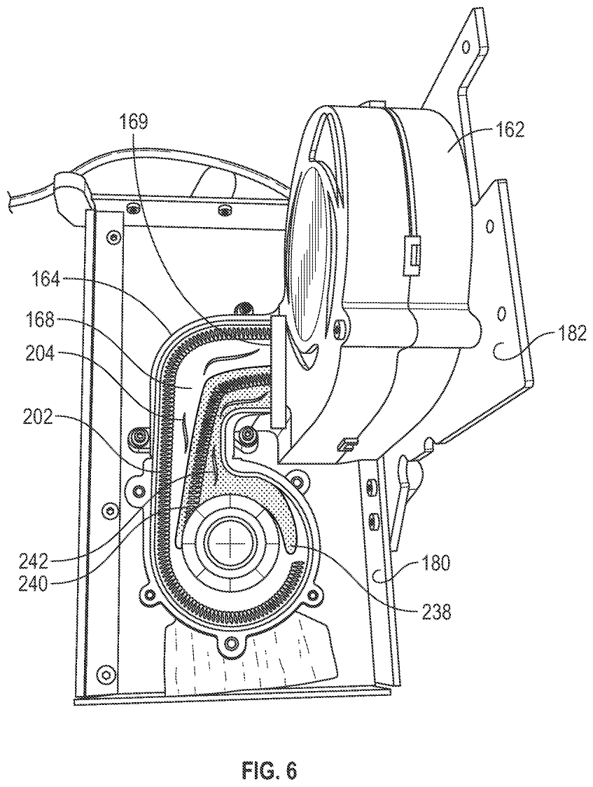

In aspects, where multiple fluid passages 168, 238, are present, such as illustrated in FIG. 6, fluids A of different temperatures may be introduced through the fluid nozzle 170 and impinge upon the bead 244 of filament 144. For example, in aspects forced fluid A leaving the fluid nozzle 170 ahead of the extrusion nozzle 120 in the direction of printing exhibits a higher temperature than the temperature of fluid A leaving the fluid nozzle 170 trailing the extrusion nozzle 120.

The temperature of the process chamber 206 (see FIG. 5), in aspects, is also adjustable through the use of heaters 208 in the process chamber 206. In aspects, the heaters 208 are resistive heaters or infrared heaters. The heaters 208 are connected to the controller 232 and the controller 232 controls the heaters 208 in combination with the heating elements 202 of the forced convection thermal management system 160. In further aspects, the heaters 208 maintain the temperature of the process chamber 206 at a temperature in the range of 20 degrees Celsius to plus 10 degrees of the glass transition temperature of the filament 144. The glass transition temperature is understood herein as the temperature at which onset of segmental motion of the polymer backbone occurs. However, it may be appreciated that some polymer materials have glass transition temperatures near or below room temperature, i.e., 21 degrees Celsius, and thus, in some cases the temperature of the process chamber is maintained at range between 20 degrees Celsius to less than 10 degrees under the heat deflection temperature of the filament 144.

In aspects, the forced convention thermal management system 160 provides a method and system for inducing property variations in a three-dimensional component 101. The property variations include variations in mechanical properties, such as tensile strength, and variations in physical properties, such as crystallinity. The property variations may be altered in a step transition at a single region or altered in a gradient across a region of the three-dimensional component 101 through the alteration of the temperature of the fluid A, or flow rates of the fluid A, as noted above.

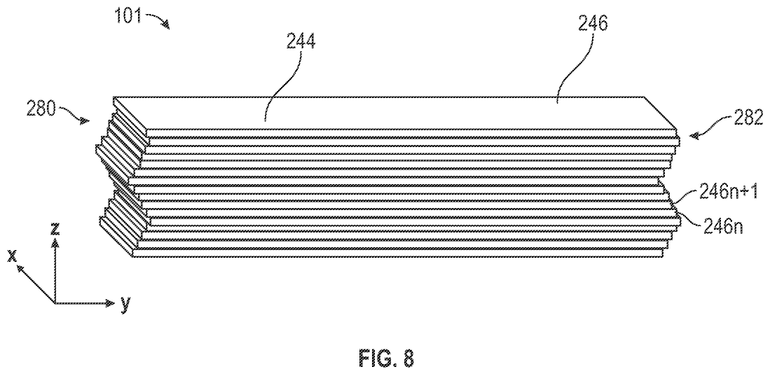

FIG. 8 illustrates an aspect of a three-dimensional component 101 printed with a three-dimensional printer 100 including a forced convention thermal management system 160 as described above. The printed three-dimensional component 101 includes a plurality of layers 246 formed by extruding a bead 244 of filament 144. As discussed above, each layer 246 is printed and the layers 246 are laid sequentially on top of each other, such as layer 246n and layer 246n+1, in a build direction, which is illustrated as coinciding with the z-axis. If the layers are planar, the plane may be oriented in the x-y plane defined by the x-axis and the y-axis.

As previously discussed, to vary and tailor the properties using the forced convection thermal management system 160, during the process of printing the three-dimensional component 101, the temperature of the fluid A exiting the fluid nozzle 170 is varied. For example, the fluid temperature is varied when depositing a bead 244 of filament 144 between each end 280, 282 of the three-dimensional component 101 in a given layer 246. The temperature of the fluid A may be adjusted at a point, along a portion 286 of the length of one or more deposited beads 244 of filament 144 in the given layer 246 or along the entire length of one or more deposited beads 244 of filament 144 in a given layer 246. Further, the temperature of the fluid A may be adjusted between one or more successive layers 246.

In aspects where it is desirable to reduce the adhesion between two or more layers 246 in the three-dimensional component, the temperature of the fluid A may be reduced to cool an underlying layer 246n while depositing the next layer 246n+1, as alluded to above. In aspects, just a portion of the layer 264n is treated with cooler fluid A, or the entire layer 246n is treated with cooler fluid A. The fluid temperature is, in aspects, at least 10 degrees less than the heat deflection temperature of the filament 144 including all values and ranges from 20 degrees Celsius to 10 degrees less than the heat deflection temperature. This reduces layer adhesion and potentially creates a weak spot in the z-direction, reducing mechanical properties, such as tensile strength, impact resistance, change in elongation at breakage, elastic modulus when measured in the z-direction. Further, where it may be desirable to reduce crystal growth or nucleation in the bead 244 of filament 144, or in the bulk three-dimensional component 101, formed with a crystalline polymer by impinging the bead 244 of filament 144 with fluid A exhibiting a temperature cooler than the crystalline melting temperature of the polymer supplied by the forced convection thermal management system.

The forced convection printer head thermal management system and method of adjusting the surface temperature of a bead of filament of the present disclosure offer several advantages. These advantages may include, for example, improved interlayer bonding of the three-dimensional printed component. These advantages may also include in an improvement in dimensional stability of a three-dimensional printed components, particularly in dense printing areas where cooling may be used to regulate thermal build-up. These advantages may further include increased predictability of the mechanical properties of printed components. These advantages may further include providing component with near, or at least improved, isotropic properties with properties in the z-x plane approaching those in of the bulk material. These advantages may yet further include tailorable properties, which may vary based on location or in gradients through the bulk of the printed component. These advantages may also include the reduction of internal stresses and component defects.

Accordingly, the present disclosure is directed, at least in part, to a printer head including a support frame, a thermal management system mounted to the support frame, and an extrusion nozzle mounted to the support frame.

In aspects, the thermal management system includes an air supply and a fluid passage. The fluid passage is defined by a fluid duct coupled to the air supply and a fluid nozzle coupled to the fluid duct and the fluid duct includes a heating element. In addition, the fluid nozzle defines an opening. The extrusion nozzle includes a first end and a second end, wherein the extrusion nozzle is mounted to the support frame at the first end of the extrusion nozzle and the second end of the extrusion nozzle extends through the opening of the fluid nozzle.

In further aspects of the above, the thermal management system is supported by a tray, wherein the tray is affixed to the support frame and the tray includes a base and an opening defined in the base of the tray through which the extrusion nozzle extends.

In any of the above aspects, the extrusion nozzle is affixed to the support frame independent of the tray and is movable relative to the tray.

In any of the above aspects, the thermal management system includes at least two fluid passages. In addition, in any of the above aspects, a second fluid passage is defined in the fluid duct and the fluid nozzle.

In any of the above aspects, the thermal management system includes a temperature detector in operative communication with the fluid nozzle.

In any of the above aspects, the fluid duct defines at least one fin in the fluid passage.

In any of the above aspects, the thermal management system includes a gasket defining an opening, wherein the gasket is mounted on the fluid duct and the extrusion nozzle passes through the gasket opening.

In any of the above aspects, a cooling system is integrated with the thermal management system and the cooling system is coupled to the fluid passage.

In addition, the present disclosure includes a three-dimensional printer including a printer head according to any of the above aspects, the printer head being mounted in a printer housing, wherein the printer head is movable in at least one plane and the printer head includes a support frame. The printer further includes a support bed, wherein the support bed is movable relative to the printer head in the printer housing.

In any of the above aspects, the temperature detector is operatively connected to a controller, wherein the controller controls the heating element in the thermal management system using a temperature measured by the temperature detector.

Further, the present disclosure is directed to a method of thermally managing printed filament temperature through forced convection using the printer and printer head in any of the aspects described above.

In aspects, the method of thermally managing printed filament temperature through forced convection includes extruding a bead of a filament through an extrusion nozzle to form a first layer of the bead, wherein the extrusion nozzle is affixed to a support frame. The method further includes forcing fluid through a fluid passage with an air supply, wherein the fluid passage includes a fluid duct and a fluid nozzle and the fluid duct includes at least one heating element and the fluid passage and air supply are included in a thermal management system. The method yet further includes impinging the fluid against the bead of the first layer and extruding additional bead of filament through the extrusion nozzle to form a second layer of the bead, wherein the fluid alters a temperature of the first layer. The method also includes bonding the first layer of the bead to the second layer of the bead.

In further aspects, the method includes raising the fluid to a temperature with the heating element, wherein the temperature is in a range of plus or minus ten degrees of a heat deflection temperature of a material forming the filament.

In any of the above aspects, the fluid is supplied to the fluid nozzle at a temperature less than a heat deflection temperature of the filament and the method further comprises cooling the first layer of the bead.

In any of the above aspects, the fluid exhibits a first temperature and is adjusted from the first temperature to a second temperature as at least one of the first layer of the bead and the second layer of the bead is being printed.

The present disclosure is also directed to a method of tailoring the properties of a three-dimensionally printed component through forced convection thermal management using the printer and printer head described in any of the above aspects.

In aspects, the method includes extruding a bead of a filament through an extrusion nozzle to form a three-dimensional component, wherein the extrusion nozzle is affixed to a support frame. The method further includes forcing fluid through a fluid passage with an air supply, wherein the fluid passage includes a fluid duct and a fluid nozzle and the fluid duct includes at least one heating element and the fluid passage and air supply are included in a thermal management system. The method also includes impinging the fluid against the bead, wherein the fluid exhibits a fluid temperature and the fluid temperature is altered while printing the three-dimensional component.

The description of the present disclosure is merely exemplary in nature and variations that do not depart from the gist of the present disclosure are intended to be within the scope of the present disclosure. Such variations are not to be regarded as a departure from the spirit and scope of the present disclosure.

What is claimed is:

1. A printer head, comprising:
a thermal management system including:
a fluid passage defined by a fluid duct coupled to an air supply,
a fluid nozzle coupled to the fluid duct,
a first opening defined in the fluid nozzle, and
a heating element included in the fluid duct; and
an extrusion nozzle, including a first end and a second end, the first end of the extrusion nozzle is mounted to a support frame and the second end of the extrusion nozzle extends through the first opening defined in the fluid nozzle.

2. The printer head of claim 1, wherein the thermal management system is supported by a tray affixed to the support frame, and the tray includes a base and a second opening is defined in the base of the tray and the extrusion nozzle extends through the second opening.

3. The printer head of claim 1, wherein the extrusion nozzle is affixed to the support frame independent of the tray and is movable relative to the tray.

4. The printer head of claim 1, wherein the thermal management system includes at least two fluid passages defined by the fluid duct.

5. The printer head of claim 1, wherein the thermal management system includes a second fluid passage defined in the fluid duct and the fluid nozzle.

6. The printer head of claim 1, wherein the thermal management system includes a temperature detector in operative communication with the fluid nozzle.

7. The printer head of claim 1, wherein the fluid duct defines at least one fin in the fluid passage.

8. The printer head of claim 1, wherein the thermal management system includes a gasket defining a gasket opening, wherein the gasket is mounted on the fluid duct and the extrusion nozzle passes through the gasket opening.

9. The printer head of claim 1, further comprising a cooling system coupled to the fluid passage.

10. A three-dimensional printer comprising:
a printer head mounted in a printer housing, wherein the printer head is movable in at least one plane and the printer head includes a support frame;
a support bed, wherein the support bed is movable relative to the printer head in the printer housing;
a thermal management system, wherein the thermal management system includes an air supply and a fluid passage;
a fluid duct coupled to the air supply and a fluid nozzle coupled to the fluid duct, the fluid duct includes a heating element, and the fluid nozzle defining an opening; and
an extrusion nozzle, including a first end and a second end, wherein the extrusion nozzle is mounted to the support frame at the first end of the extrusion nozzle and the second end of the extrusion nozzle extends through the opening of the fluid nozzle.

11. The three-dimensional printer of claim 10, wherein the thermal management system is supported by a tray, wherein the tray is affixed to the support frame and the tray includes a base and an opening defined in the base of the tray through which the extrusion nozzle extends.

12. The three-dimensional printer of claim 11, wherein the extrusion nozzle is affixed to the support frame independent of the tray and is movable relative to the tray.

13. The three-dimensional printer of claim 10, wherein the thermal management system includes at least two fluid passages.

14. The three-dimensional printer of claim 10, wherein the thermal management system includes a temperature detector operatively coupled to the fluid nozzle and connected to a controller, wherein the controller controls the heating element using a temperature measured by the temperature detector.

15. The three-dimensional printer of claim 10, wherein the fluid duct defines at least one fin in the fluid passage.

16. The three-dimensional printer of claim 10, further comprising a cooling system is integrated with the thermal management system.

17. A method of thermally managing printed filament temperature comprising:
extruding a bead of a filament through an extrusion nozzle to form a first layer of the bead, wherein the extrusion nozzle is affixed to a support frame;
forcing fluid through a fluid passage with an air supply, wherein the fluid passage includes a fluid duct and a fluid nozzle and the fluid duct includes at least one heating element and the fluid passage and air supply are included in a thermal management system;
impinging the fluid against the bead of the first layer and extruding additional bead of filament through the extrusion nozzle to form a second layer of the bead, wherein the fluid alters a temperature of the first layer; and
bonding the first layer of the bead to the second layer of the bead.

18. The method of claim 17, further comprising raising the fluid to a temperature with the heating element, wherein the temperature is in a range of plus or minus ten degrees of a heat deflection temperature of a material forming the filament.

19. The method of claim 17, further comprising supplying the fluid to the fluid nozzle at a temperature less than a heat deflection temperature of the filament; and cooling the first layer of the bead.

20. The method of claim 17, wherein the fluid exhibits a first temperature and the method further comprises adjusting the fluid from the first temperature to a second temperature as at least one of the first layer of the bead and the second layer of the bead is being printed.
